(19) United States
(12) Patent Application Publication
(10) Pub. No.: US 2013/0280345 A1
(43) Pub. Date: Oct. 24, 2013

(54) ANTIMICROBIAL AGENT FOR THE BIOCIDAL FINISHING OF POLYMERS, IN PARTICULAR OF FOAM MATERIALS

(71) Applicant: Karl Rametsteiner, Linz (AT)

(72) Inventor: Karl Rametsteiner, Linz (AT)

(73) Assignee: WENATEX FORSCHUNG - ENTWICKLUNG - PRODUKTION GMBH, Salzburg (AT)

(21) Appl. No.: 13/992,876

(22) PCT Filed: Aug. 30, 2012
(86) PCT No.: PCT/AT2012/050121

§ 371 Date: Jun. 10, 2013

(30) Foreign Application Priority Data
Sep. 6, 2011 (AT) A 1266/2011

(51) Int. Cl. A01N 59/16

(52) U.S. Cl. CPC A01N 59/16
USPC 424/618

(57) ABSTRACT

The invention describes an antimicrobial agent for the biocidal finishing of polymers, especially foam materials, based on a fine-pored foamed and fine-grained ground silvered glass, which in addition to a silver fraction also contains a fraction of zinc oxide. In order to provide an economical antimicrobial agent with good biocidal effect it is proposed that zinc oxide powder is admixed to the fine-grained silvered glass.

### FIELD OF THE INVENTION

The invention relates to an antimicrobial agent for the biocidal finishing of polymers, especially foam materials, based on a fine-pored foamed and fine-grained ground silvered glass, which in addition to a silver fraction also contains a fraction of zinc oxide.

### DESCRIPTION OF THE PRIOR ART

It is known for the biocidal finishing of foam materials, especially open-pore polyurethane-based soft foam materials, to use silver-containing glasses which are foamed in the highest fine-pored way in the course of the solidification of the melt and are then ground, so that a fine-grained powder is obtained with a grain size of preferably less than 5 μm. Since the porosity of the grains is maintained, a large specific surface is obtained which can provide a large number of silver ions as charge carriers for the biocidal effect. The antimicrobial agent which consists of such a silver-containing glass will be added in the usual way to the polyol component before the polyurethane foam material which is finished in a biocidal way can be obtained by a polyaddition reaction with an isocyanate conmponent under the action of a blowing agent. A fraction of the antimicrobial agent in the foam of approx. 2% by weight has proven to be advantageous for the desired antimicrobial effect. The comparatively high costs for the silvered glass have proved to be disadvantageous however, which glass has a weight fraction of usually 3 to 3.5% by weight. In order to reduce the silver fraction it has already been proposed to replace a part of the silver content of these silvered glasses by zinc oxide, wherein a slight improvement in the antimicrobial effect is even obtained when these silvered glasses have a zinc oxide fraction of 10 to 15% by weight at a silver fraction of 2.5 to 3% by weight. The reductions in cost are comparatively low however.

### SUMMARY OF THE INVENTION

The invention is based on the object of providing an antimicrobial agent for the biocidal finishing of polymers, especially foam materials, of the kind mentioned above in such a way that the antimicrobial effect can be increased under advantageous economic conditions.

This object is achieved by the invention in such a way that zinc oxide powder is admixed to the fine-grained silvered glass.

As a result of the admixture of the zinc powder to the silvered glass, which contains a zinc oxide fraction itself, the biocidal effect of the foam materials equipped with such an antimicrobial agent can surprisingly be increased to a considerable extent. This is astonishing because the use of a zinc oxide powder in connection with a silvered glass powder without zinc fraction has a rather adverse effect on the antimicrobial effect. As a result of the increase in the biocidal effect of the antimicrobial agent in accordance with the invention, it is either possible to utilize the higher biocidal effect or the fraction of the antimicrobial agent can be reduced for economic reasons without having to accept any disadvantages in comparison with the state of the art concerning the desired biocidal effect.

Although the effect of the fine-grained silvered glass which has a zinc oxide fraction can advantageously be used in conjunction with an additionally admixed zinc oxide powder in connection with biocidal finishing of foam materials for different fields of use, especially advantageous conditions are obtained in the biocidal finishing of foam material mattresses and foam material supports especially for use in hospitals because high hygienic demands can be fulfilled with this biocidal finishing.

In order to ensure the desired biocidal effect for conventional applications, the mixture of the fine-grained silvered glass and the zinc oxide powder can have a fraction of zinc oxide powder which corresponds to twice to 20 times the quantity of the zinc oxide fraction in the silvered glass. Especially advantageous effects will be achieved when the mixture of silvered glass and zinc oxide powder has a quantity of zinc oxide powder which corresponds to 10 to 20 times the zinc oxide quantity in the silvered glass.

As already mentioned above, the effect of the biocidal finishing off a foam material not only depends on the antimicrobial properties, but also on the quantity and the specific surface of the employed agent. It is therefore recommended for this reason to use a zinc oxide powder with a specific surface of between 2 and 10 m²/g. Preferred are zinc oxide powders with a specific surface of between 4 and 8 m², which corresponds to an average grain size of between 200 and 400 nm.

The silvered glasses used as antimicrobial agents are conventionally composed of 9 to 14% by weight of sodium oxide, 1 to 4% by weight of potassium oxide, 1 to 5% by weight of calcium oxide, 5 to 8% by weight of aluminium oxide, 50 to 55% by weight of silicon dioxide, 5 to 10% by weight of boron trioxide, 2.5 to 3% by weight of silver, and 10 to 15% by weight of zinc oxide.

In order to test the effect of the antimicrobial agent in accordance with the invention, this agent was added in different quantities with different fractions of free zinc oxide to a polyol component, and said polyol component was mixed with an isocyanate component for foaming reaction in an open vessel.

The test concerning the antimicrobial activity occurred according to the Japanese industrial standard JIS Z 2801:2000. Escherichia coli (DSM 787) and staphylococcus aureus (DSM 346) were used as test bacteria, wherein the reduction number IR was determined for quantify the effectiveness of the biocidal finishing of the samples. A distinct antimicrobial effect of the evaluated samples is given by a reduction factor of 2, which rises logarithmically with increasing reduction factor.

The polyol component comprised 99 g of a trifunctional basic polyol (molecular weight of 2500 to 3000 g/mol), 3.5 g of water as a blowing agent, 1.2 g of a silicon stabilizer and 1.3 g of a foaming catalyst. The di-isocyanate component comprised 65 g of diphenylmethane diisocyanate with a content in the isocyanate group of 29.5% by weight. After the addition of an antimicrobial agent in accordance with the invention, the isocyanate component and the polyol component were converted by a polyaddition reaction into an open-celled soft foam material with a weight by volume of approx. 40 kg/m³.

### EXAMPLE 1

3.4 g of a silvered glass with a silver content of 3.4% by weight was added to the polyol component. The silvered glass did not contain any zinc oxide.

### EXAMPLE 2

3.4 g of a silvered glass with 3.0% by weight of silver and 12% by weight of zinc oxide were used as an antimicrobial agent.

### EXAMPLE 3

3.0 g of silvered glass according to example 1 was mixed with 0.4 g of zinc oxide with a specific surface of 2.2 m²/g for the biocidal finishing of the foam material. This addition of zinc oxide corresponds by quantity to the zinc oxide content of the silvered glass according to example 2.

### EXAMPLE 4

3.0 g of silvered glass according to example 2 was used in accordance with the invention together with 0.8 g of zinc oxide (specific surface of 2.2 m²/g) as an antimicrobial agent, with a ratio of approx. 1:2 being present with respect to the molar masses of the zinc oxide bonded in the silvered glass and the free zinc oxide.

### EXAMPLE 5

The employed antimicrobial agent corresponded to the one of example 4, but 4.0 g of zinc oxide were added to the fine-grained silvered glass, so that they molar mass ratio of 1:11 was obtained.

### EXAMPLE 6

1.5 g of a silvered glass according to example 2 was mixed with 1.6 g of zinc oxide (specific surface of 2.2 m²/g) into an antimicrobial agent (molar mass ratio 1:9).

### EXAMPLE 7

0.75 g of a silvered glass according to example 2 was used together with 1.8 g of zinc oxide (specific surface of 2.2 m²/g) as an antimicrobial agent (molar mass ratio 1:20).

### EXAMPLE 8

an antimicrobial agent according to example 7 was used with the difference that the specific surface of the zinc oxide was 4 m²/g.

### EXAMPLE 9

an antimicrobial agent according to example 7 was changed with respect to the specific surface of the zinc oxide. The specific surface of the zinc oxide was 6 m²/g.

### EXAMPLE 10

The specific surface of the zinc oxide according to example 7 was changed again, namely to 8 m²/g.

Samples 1 to 10 of open-celled soft foam material were produced in the stated manner with the antimicrobial agents according to the examples 1 to 10 under conditions that correspond otherwise, and the antimicrobial activity was determined according to the Japanese industrial standard JIS Z 2801:2000 by determining the reduction factor IR for escherichia coli (Gram-positive) and staphylococcus aureus (Gram-negative) after a period of one week. The results are summarised in the table below.

| | IR | IR |
|---|---|---|
| Sample No. | E. coli | S. aureus |
| 1 | 2.2 | 2.0 |
| 2 | 2.4 | 2.2 |
| 3 | 2.1 | 2.1 |
| 4 | 2.2 | 2.1 |
| 5 | 3.2 | 3.8 |
| 6 | 2.4 | 2.8 |
| 7 | 2.4 | 2.8 |
| 8 | 2.6 | 2.8 |
| 9 | 2.7 | 2.9 |
| 10 | 2.8 | 3.2 |

The reduction factors show directly that the addition of a zinc oxide powder to a silvered glass without zinc oxide content according to example 3 does not lead to any improvement in the antimicrobial effect in comparison to biocidal finishing with a silvered glass without zinc oxide content according to example 1, but that already a silvered glass with a zinc oxide fraction leads to a slight improvement in the biocidal effect. Sample 4 shows that with a free zinc oxide fraction according to twice the zinc content of the silvered glass there will already be a slight improvement in the desired effect in comparison with a silvered glass without zinc oxide. The increase in the free zinc content noticeably raises the biocidal effect, as is confirmed by sample 5. Consequently, the fraction of the silvered glass can be reduced substantially in order to ensure its biocidal effect which is comparable to the silvered glasses without additional free zinc oxide powder, as is confirmed by the samples 6 and 7, which entail substantial economic advantages due to the considerably reduced content of silvered glass in comparison with sample 4, without having to forego a sufficient biocidal effect.

The influence of the grain size of the free zinc oxide on the biocidal effect is shown in the examples 8 to 10. The biocidal effect will increase with increasing specific surface of the zinc oxide powder, so that the employed antimicrobial agent can be adjusted to the respective requirements placed on the foam material which is finished in a biocidal manner by means of this agent by means of this influencing quantity too.

1. An antimicrobial agent for the biocidal finishing of polymers, especially foam materials, based on a fine-pored foamed and fine-grained ground silvered glass, which in addition to a silver fraction also contains a fraction of zinc oxide, wherein zinc oxide powder is admixed to the fine-grained silvered glass.

2. An antimicrobial agent according to claim 1, wherein the mixture of fine-grained silvered glass and the zinc oxide powder has a fraction of zinc oxide powder which corresponds to twice to 20 times the quantity of the zinc oxide fraction in the silvered glass.

3. An antimicrobial agent according to claim 2, wherein the mixture of silvered glass and zinc oxide powder comprises a quantity of zinc oxide powder which corresponds to 10 to 20 times the quantity of zinc oxide in the silvered glass.

4. An antimicrobial agent according to claim 1, wherein the zinc oxide powder has a specific surface of between 2 and 10 m²/g.

5. An antimicrobial agent according to claim 4, wherein the zinc oxide powder has a specific surface of between 4 and 8 m2/g.
